(19) United States
(12) Patent Application Publication
(10) Pub. No.: US 2014/0301567 A1
(43) Pub. Date: Oct. 9, 2014

(54) METHOD FOR PROVIDING A COMPENSATION SERVICE FOR CHARACTERISTICS OF AN AUDIO DEVICE USING A SMART DEVICE

(71) Applicant: Eun Dong Kim, Anyang (KR)

(72) Inventor: Eun Dong Kim, Anyang (KR)

(21) Appl. No.: 14/345,938

(22) PCT Filed: Sep. 20, 2012
(86) PCT No.: PCT/KR2012/007562

§ 371 Date: Mar. 19, 2014

(30) Foreign Application Priority Data
Sep. 20, 2011 (KR) 10-2011-0094919

(51) Int. Cl. H04R 3/04

(52) U.S. Cl. CPC H04R 3/04
USPC 381/94.1

(57) ABSTRACT

The present invention relates to a method of providing a compensation service for characteristics of a sound system using a smart device comprises: (1) receiving information of the sound system from the smart device; (2) retrieving the inputted sound characteristics of the sound system; and (3) transmitting a compensation signal according to the sound characteristics to the smart device. A user can be provided with a sound compensation service according to the sound characteristics of his/her sound system, i.e. a speaker, an earphone or a headphone, just by allowing a service providing server to receiving information about the sound system from the smart device, retrieving the sound characteristics, and then transmitting a compensation signal according to the sound characteristics to the smart device.

### BACKGROUND OF THE INVENTION

The present invention disclosed herein relates to a method of providing a sound compensation service, and more particularly, to a method of providing a compensation service for the characteristics of a sound system using a smart device.

Recently, along with the development of various kinds of personal information communication devices, people can live a civilized life such as enjoying of music contents and multimedia contents using the personal information communication devices. In modern society, many people keep in touch with various kinds of sound players. Examples of sound players include TVs, AM-FM radios, CD players, MP3 players, stereo systems, PCs, and language learning players.

On the other hand, sounds outputted from various kinds of sound players or sound systems may be outputted differently from actual sounds according to the characteristics of the sound players and systems. For example, in case of frequency response characteristics, an equalizer is being used to compensate for sounds distorted by various kinds of sound players or systems. The equalizer, which is used to improve the frequency characteristics, refers to an apparatus that restores a signal with nonuniform frequency characteristics to a signal with the original frequency characteristics. For example, when the bass response is reduced in a hall where the bass response is emphasized according to the sound characteristics, sounds are uniformly heard to the audience, which is called equalizing and is performed by the equalizer.

Sound systems have different output characteristics according to various characteristics of the sound systems. However, there is a limitation in that a typical equalizer or equalizer program cannot sufficiently consider the characteristics of the sound systems. Also, since various kinds of sound playable devices such as smart devices are recently popularized, a user can listen to music or enjoy multimedia contents without a separate portable sound player. However, an apparatus or program for considering their own sound characteristics of the sound playable devices is not yet developed.

In addition, users desiring a more improved sound quality use expensive earphones or headphones and speakers connected to the smart devices. However, it is difficult for an ordinary person to consider the sound characteristics of sound devices such as earphones, headphones, and speakers in detail. Even though a user finds the sound characteristics of the sound devices, an equalizer that can enable delicate compensation according to the features of individual products is not yet developed. Accordingly, as the number of user using smart devices increases and demands for high quality sound increase, the development of sound play programs for smart devices, which can consider the individual characteristics of various kinds of sound systems, is urgent.

### SUMMARY OF THE INVENTION

The present invention provides a method of providing a compensation service for the characteristics of a sound system using a smart device, which can perform equalizing in consideration of the output characteristics according to the sound systems, and is convenience for use because a user can be provided with a sound compensation service according to the sound characteristics of his/her sound system without directly finding the sound characteristics of his/her sound system, by allowing a service providing server to receiving information about the sound system from the smart device, retrieving the sound characteristics, and then transmitting a compensation signal according to the sound characteristics to the smart device.

The present invention also provides a method of providing a compensation service for the characteristics of a sound system using a smart device, which can enable a change of a realistic tone and an expression about a space due to the reflection of the individual characteristics of the sound system even though the same artificial sound field is applied, by receiving sound setting information from the smart device and transmitting a compensation signal according to the sound characteristics and the sound setting information to the smart device while transmitting the compensation signal using the sound setting information in accordance with the taste of a user and reflecting the sound characteristics of the sound system.

Embodiments of the present invention provide methods of providing a compensation service for characteristics of a sound system using a smart device, the method comprising: (1) receiving, by a service providing server providing the sound compensation service, information of the sound system from the smart device; (2) retrieving, by the service providing server, the inputted sound characteristics of the sound system; and (3) transmitting, by the service providing server, a compensation signal according to the sound characteristics to the smart device, wherein the smart device is installed with an application program for performing a compensation for the characteristics of the sound system, and the application program compensates for an output parameter of the sound system according to the compensation signal.

In some embodiments, the method may further include (0) storing, by the service providing server, the characteristics according to the sound system in a database;

In other embodiments, the sound system may include at least one of a speaker embedded in the smart device, an earphone, a headphone, and an external speaker.

In still other embodiments, (1) the receiving of the information of the sound system may include: (1-1) transmitting a list of the sound systems to the smart device; and (1-2) receiving at least one of the list from the smart device.

In even other embodiments, in (1) the receiving of the information of the sound system, the information may include manufacturer and product names.

In yet other embodiments, the smart device may be installed with an application program for performing a compensation for the characteristics of the sound system

In further embodiments, the application program may compensate for an output parameter of the sound system according to the compensation signal.

In still further embodiments, the method may further include receiving sound setting information from the smart device. Here, (3) the transmitting of the compensation signal may include transmitting a compensation signal according to the sound characteristics and the sound setting information.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a configuration of a system for implementing a method of providing a compensation service for the characteristics of a sound system using a smart device according to an embodiment of the present invention;

FIG. 2 is a view illustrating a detailed configuration of a service providing server in a system for implementing a method of providing a compensation service for the characteristics of a sound system using a smart device according to an embodiment of the present invention;

FIG. 3 is a flowchart illustrating a method of providing a compensation service for the characteristics of a sound system using a smart device according to an embodiment of the present invention;

FIG. 4 is a flowchart illustrating a detailed flow of operation S200 in a method of providing a compensation service for the characteristics of a sound system using a smart device according to an embodiment of the present invention;

FIG. 5 is a view illustrating a smart device in which operation S200 is performed in a method of providing a compensation service for the characteristics of a sound system using a smart device according to an embodiment of the present invention; and

FIG. 6 is a view illustrating a smart device in which sound data is outputted by a compensation signal in a method of providing a compensation service for the characteristics of a sound system using the smart device according to an embodiment of the present invention.

Reference numerals set forth in the Drawings includes reference to the following elements as further discussed below:

| | |
|---|---|
| 100: service providing server | 110: transceiver |
| 120: database | 130: retriever |
| 140: compensation signal generator | 200: smart device |
| 300: sound system | 300a: speaker embedded |
| | in smart device |
| 300b: earphone | 300c: headphone |
| 300d: external speaker | |

S100: storing sound characteristics according to sound system in
database
S200: receiving information of sound system from smart device
S210: transmitting list of sound systems to smart device
S220: receiving at least one of list from smart device
S300: retrieving sound characteristics of sound system that are
inputted
S400: receiving sound setting information from smart device
S500: transmitting compensation signal according to sound
characteristics to smart device

### DETAILED DESCRIPTION OF PREFERRED EMBODIMENTS

Hereinafter, exemplary embodiments of the present invention will be described in detail with reference to the accompanying drawings so that those skilled in the art can easily carry out the present invention. However, detailed descriptions related to well-known functions or configurations will be ruled out in order not to unnecessarily obscure subject matters of the present invention. Also, like reference numerals refer to like elements throughout.

In this disclosure below, when one part (or element, device, etc.) is referred to as being ‘connected’ to another part (or element, device, etc.), it should be understood that the former can be ‘directly connected’ to the latter, or ‘indirectly connected’ to the latter via an intervening part (or element, device, etc.). Furthermore, when it is described that one comprises (or includes or has) some elements, it should be understood that it may comprise (or include or has) only those elements, or it may comprise (or include or have) other elements as well as those elements if there is no specific limitation.

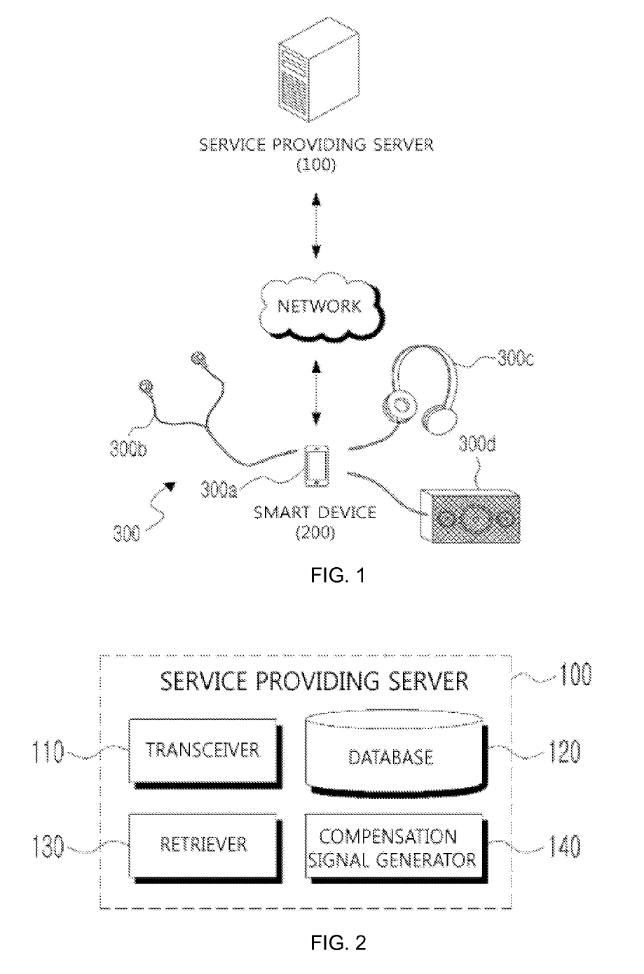

FIG. 1 is a view illustrating a configuration of a system for implementing a method of providing a compensation service for the characteristics of a sound system 300 using a smart device 200 according to an embodiment of the present invention. As shown in FIG. 1, a system for implementing a method of providing a compensation service for the characteristics of a sound system 300 using a smart device 200 according to an embodiment of the present invention may be configured to include a service providing server 100, a smart device 200, and a sound system 300.

The service providing server 100 may receive information of the sound system 300 from the smart device 200 connected through a network, and may retrieve the sound characteristics of the sound system 300 from a database 120 and then generate a compensation signal according to the sound characteristics to transmit the compensation signal to the smart device 200. The smart device 200 may compensate for an output parameter of the sound system 300 using the compensation signal transmitted from the service providing server 100, allowing compensated sound to be outputted through the sound system 300. Accordingly, unlike a typical equalizer, the present invention can perform equalizing in consideration of the output characteristics according to the sound system 300. Also, since a user does not directly know the sound characteristics of the sound system 300 and the service providing server receives the information of the sound system 300 from the smart device 200 to provide a user with the sound compensation service, the present invention may be convenient for use and excellent in sound quality.

The method of providing the compensation service for the characteristics of the sound system using the smart device can perform equalizing in accordance with the taste of a user by receiving sound setting information from the smart device 200 to transmit the compensation signal according to the sound characteristics and the sound setting information to the smart device 200. Accordingly, since the characteristics of the sound system 300 can be reflected, and the taste of a user can be reflected, the satisfaction of a user can be improved, and the sound setting can be reperformed according to music contents or multimedia contents to be played. Hereinafter, components of the system for implementing the method of providing the compensation service for the characteristics of the sound system 300 using the smart device 200 according to the embodiment of the present invention will be described in detail.

The service providing server 100, which is a server that provides a sound compensation service, may allow an access of the smart device 200 through wired/wireless networks including Internet, intranet, and mobile communication networks, and may provide a compensation service according to the characteristics of the sound system 300. That is, the service providing server 100 may store the sound characteristics according to various sound systems 300, and when receiving information of the sound system 300 from the smart device 200, may retrieve the sound characteristics of the corresponding sound system 300 to transmit a compensation signal according to the sound characteristics to the smart device 200. A detailed configuration of the service providing server 100 will be later described in detail with reference to FIG. 2.

The smart device 200 may be a user's terminal by which the service providing server 100 intends to provide the sound compensation service. The smart device 200 may not be limited in its function, and may refer to a product that can be considerably changed and extended in its function through application programs. Examples of the smart device 200 may include smart phones, tablet PCs, and smart TVs. However, the smart device 200 denotes a personal information communication device equipped with a communication unit and a sound output device, and is not limited to a form of terminal shown in the drawings. Accordingly, if any device can access the service providing server 100 through a network to transmit information of the sound system 300 and can receive a compensation signal to output a compensated sound regarding sound data or an audio part of multimedia data, the device may act as the smart device 200 of the present invention regardless of the concrete form of terminal.

Meanwhile, the smart device 200 may be equipped with an application program for performing compensation for the characteristics of the sound system 300. That is, a user can more conveniently use the sound compensation service providing method by installing and executing the application program. Also, the application program installed in the smart device 200 may compensate for and output the output parameter of the sound system 300 according to the compensation signal transmitted from the service providing server 100.

The sound system 300, which is an apparatus for outputting sound, may output sound data or an audio part of multimedia data that are stored in the smart device 200 or played in the smart device 200 by streaming service. As shown in FIG. 1, the sound system 300 may be a speaker 300a embedded in the smart device 200, but may also be an earphone 300b, a headphone 300c, and an external speaker 300d which can be connected to the smart device 200 to output sounds. The sound system 300 may be other various devices for outputting sound, and may have unique sound characteristics according to the types of products.

FIG. 2 is a view illustrating a detailed configuration of a service providing server 100 in a system for implementing a method of providing a compensation service for the characteristics of a sound system 300 using a smart device 200 according to an embodiment of the present invention. As shown in FIG. 2, the service providing server 100 of the system for implementing the method of providing the compensation service for the characteristics of the sound system 300 using the smart device 200 may be configured to include a transceiver 110, a database 120, a retriever 130, and a compensation signal generator 140.

The transceiver 110 may allow the access of the smart device through wired/wireless networks, and may transmit or receive various kinds of information and data. That is, the transceiver 110 may receive information of the sound system 300 from the smart device 200, and may transmit a compensation signal according to the sound characteristics to the smart device 200. Also, the transceiver 110 may also transmit the compensation signal according to the sound setting information inputted from the smart device 200 to the smart device 200. In this case, the transceiver 110 may also perform communication with a plurality of smart device 200.

The database 120 may store the sound characteristics according to the sound system 300. Since the sound systems 300 show different magnitudes of sound according to the output frequency range due to their characteristics, the sound systems 300 may show different characteristics that sound is clean, a low tone is cut off, or a middle tone is magnified. The database 120 may store the sound characteristics according to the sound system 300, allowing a user to know the characteristics of the sound system 300 used by the user, and thus allowing the service providing server 100 to know the sound characteristics of the sound system 300 even though the user does not input the characteristics of the sound system 300 into the service providing server 100 in detail. On the other hand, the sound characteristics stored in the database 120 may be updated periodically or according to a request of an operator of the service providing server 100 to add the sound characteristics of a new sound system 300 or correct errors of stored data.

The retriever 130 may retrieve the sound characteristics of the sound system 300 corresponding to the information of the sound system 300 inputted from the smart device 200 by the transceiver 110. When the information of the sound system 300 inputted from the transceiver 110 is multiple, the retriever 130 may retrieve all sound characteristics, and may deliver the retrieved sound characteristics to the compensation signal generator 140.

The compensation signal generator 140 may generate a compensation signal according to the sound characteristics delivered from the retriever 130, and then may deliver the compensation signal to the transceiver 110, allowing the transceiver 110 to transmit the compensation signal to the smart device 200. Also, the compensation signal generator 140 may receive the sound setting information inputted from the smart device 200 from the transceiver 110 to generate a compensation signal according to the sound setting information and then deliver the compensation signal to the transceiver 110. Particularly, when the sound setting information is inputted, the compensation signal may also be generated in consideration of both sound characteristics and sound setting.

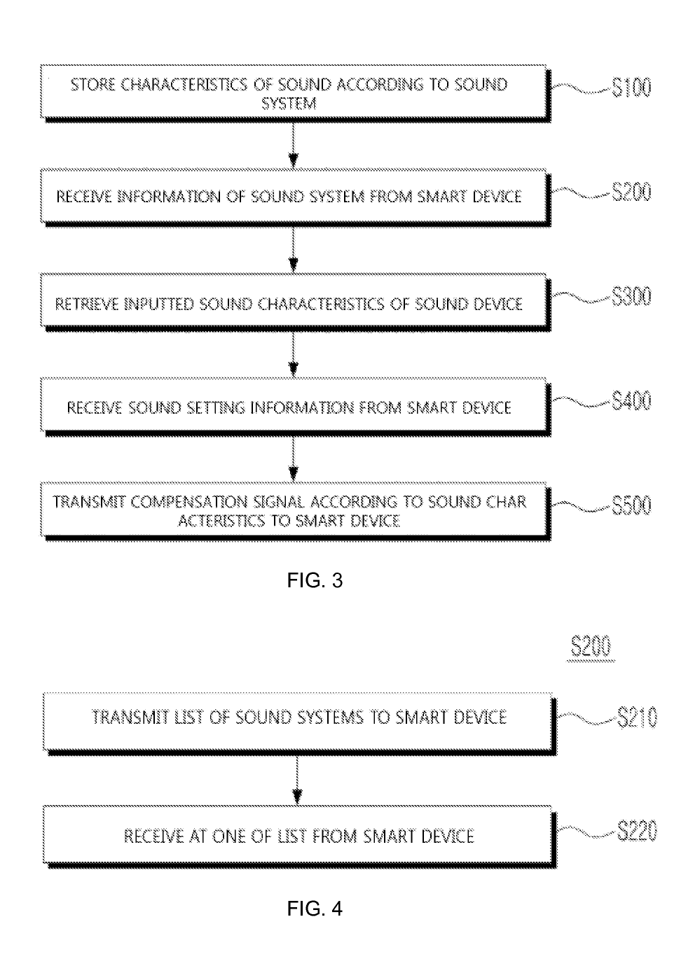

FIG. 3 is a flowchart illustrating a method of providing a compensation service for the characteristics of a sound system 300 using a smart device 200 according to an embodiment of the present invention. As shown in FIG. 3, the method of providing the compensation service for the characteristics of the sound system 300 using smart device 200 may include receiving information of the sound system 300 from the smart device 200 (S200), retrieving the inputted sound characteristics of the sound system 300 (S300), and transmitting a compensation signal according to the sound characteristics to the smart device 200 (S500), and may further include storing the sound characteristics according to the sound system 300 in a database 120 (S100) and receiving sound setting information from the smart device 200 (S400).

In operation S100, a service providing server 100 may store sound characteristics according to the sound system 300 in the database 120. For example, the audible frequency of human may range from about 20 Hz to about 20 kHz, but even in the same frequency range, outputted sound may differ according to the sound system 300. In operation S100, the database 120 of the service providing server 100 may store various sound characteristics according to the sound systems 300, enabling the understanding of the sound characteristics of the sound system 300 when the sound system 300 is known.

Meanwhile, in operation of S100, space characteristics may be further stored regarding a space where sound data or an audio portion of multimedia data are outputted, in addition to the sound characteristics of the sound system 300. Although the same sound data are outputted by the same sound system 300, sounds heard to a user may differ according to the spatial characteristics such as size of space or internal structures. Accordingly, in operation S100, the service providing server 100 may further store sound characteristics according to the spatial characteristics in the database 120, thereby reflecting the spatial characteristics.

In operation S200, the service providing server 100 may receive information of the sound system 300 from the smart device 200. The sound system 300 may include at least one of a speaker 300a, an earphone 300b, a headphone 300c, and an external speaker 300d, which is embedded in the smart device 200. For example, since the smart device 200 is equipped with the speaker 300a outputting sound to the outside, the service providing server 100 may receive information of the smart device 200. Also, since the earphone 300b, the headphone 300c, or the external speaker 300d is connected to the smart device 200, the service providing server 100 may receive information about these sound systems 300.

The information of the sound system 300 that is inputted in operation S200 may include the names of a manufacturer and a product of the sound system 300. In operation S200, the information of the sound system 300 may not be detailed information about the sound system 300, and may be simple information such as manufacturer and product name, which allows the sound system 300 to be distinguished. A detailed flow of operation S200 will be later described in detail with reference to FIG. 4.

In operation S300, the sound characteristics of the sound system 300 received by the service providing server 100 may be retrieved. The retriever 130 of the service providing server 100 may retrieve the sound characteristics of the sound system 300 using the information stored in the database 120 in operation S100. According to an embodiment, in operation of S300, the space characteristics to which sound is outputted, as well as the sound characteristics of the sound system 300, may be retrieved.

In operation S400, the service providing server 100 may receive sound setting information from the smart device 200. The sound setting information may be inputted for a user to hear music with a desired tone, and may be variously set such that, for example, a low tone is strong and a high tone is weak according to the taste of a user. for example, in operation S400, the service providing server 100 may provide the smart device 200 with an interface using an application program so as to enable sound adjustment by frequency range and add various effects. A user may input the sound setting information into the service providing server 100 through the sound adjustment desired by a user, and may listen to sound data or an audio portion of multimedia data that is implemented similarly to desired tones or sounds of high-quality products of other manufacturers.

Meanwhile, the service providing server 100 may provide at least one piece of predetermined sound setting information, enabling a user to input the sound setting information. For example, sound setting information recommended for listening to classic music and sound setting information recommended for watching movies may be beforehand stored to be provided to a user, allowing a user to select and input one piece of predetermined sound setting information.

In operation S500, the service providing server 100 may transmit a compensation signal according to the sound characteristics to the smart device 200. In other words, the compensation signal generator 140 may generate a compensation signal according to the sound characteristics that are retrieved in operation S300, and then the service providing server 100 may transmit the compensation signal to the smart device 200. In this case, In operation S500, when the sound setting information is inputted from the smart device 200 in operation S400, a compensation signal according to the sound characteristics and the sound setting information may be generated to be transmitted to the smart device 200.

The smart device 200 receiving the compensation signal transmitted in operation S500 may perform equalizing by compensating for an output parameter of the sound system 300 according to the compensation signal. Upon outputting of sound data, the smart device 200 may display the characteristics of sound equalized according to the sound characteristics of the sound system 300 through the display unit of the smart device 200, allowing a user to visually confirm the compensation and thus improving the satisfaction of a user.

FIG. 4 is a flowchart illustrating a detailed flow of operation S200 in a method of providing a compensation service for the characteristics of a sound system 300 using a smart device 200 according to an embodiment of the present invention. As shown in FIG. 4, the operation S200 of the method of providing the compensation service for the characteristics of the sound system 300 using the smart device 200 according to the embodiment of the present invention may be configured to include transmitting a list of the sound systems 300 to the smart device 200 (S210) and receiving at least one of the list from the smart device 200 (S220).

In operation S210, the service providing server 100 may transmit the list of the sound systems 300 to the smart device 200. In other words, the service providing server 100 may provide the list of the sound systems 300, the sound characteristics of which are stored in the database 120 to help the input of a user. Also, according to embodiments, when an application program installed in the smart device 200 is executed to perform compensation for the characteristics of the sound system 300, the sound system 300 such as a speaker 300a embedded in the smart device 200 and an earphone 300b, a headphone 300c, or an external speaker 300d connected to the smart device 200 may be automatically recognized, thereby outputting the list of the sound systems 300 that are automatically recognized to the smart device 200.

In operation S220, the service providing server 100 may receive at least one of the list from the smart device 200. In operation S210, the selection of the sound system 300 used by a user may be inputted from the list of the sound system 300 transmitted by the service providing server 100. Since a user can use various sound systems 300, the sound system 300 may be inputted in plurality in operation S220. In operation S500, when a plurality of sound systems 300 are inputted from the smart device 200 in operation S220, a plurality of compensation signals may be transmitted to the smart device 200. Thus, when outputted to the speaker 300a embedded in the smart device 200 or outputted to the earphone 300b, different compensation signals may also be used according to the types of the sound system 300 for outputting.

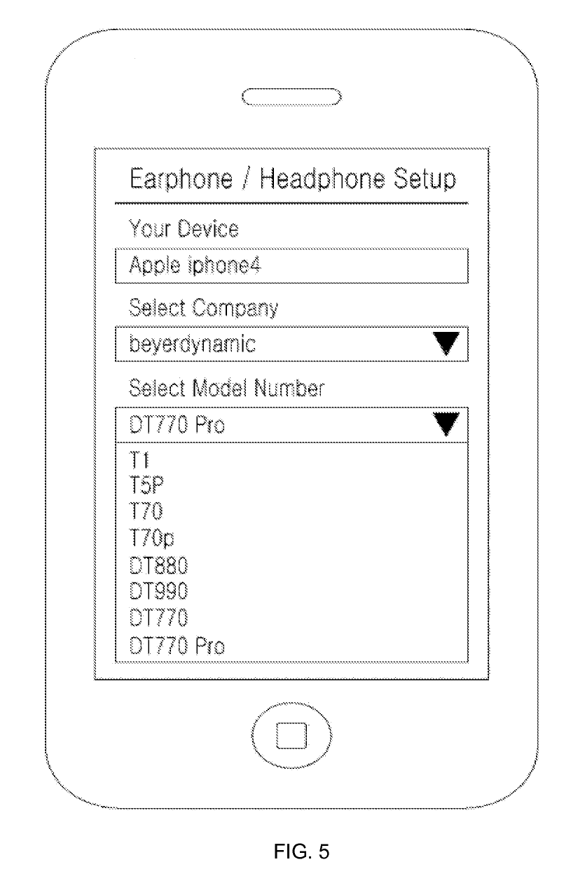

FIG. 5 is a view illustrating a smart device 200 in which operation S200 is performed in a method of providing a compensation service for the characteristics of a sound system 300 using a smart device 200 according to an embodiment of the present invention. For example, as shown in FIG. 5, the smart device 200, which is an Apple iPhone 4, may retrieve sound characteristics of the speaker 300a embedded in the corresponding smart device, and may transmit a compensation signal in operations S300 and S500. Since additional devices such as the earphone 300b, the headphone 300c, or the external speaker 300d may not be connected to the smart device 200, a list of manufacturers and model names may be provided such that a user can directly select the additional devices.

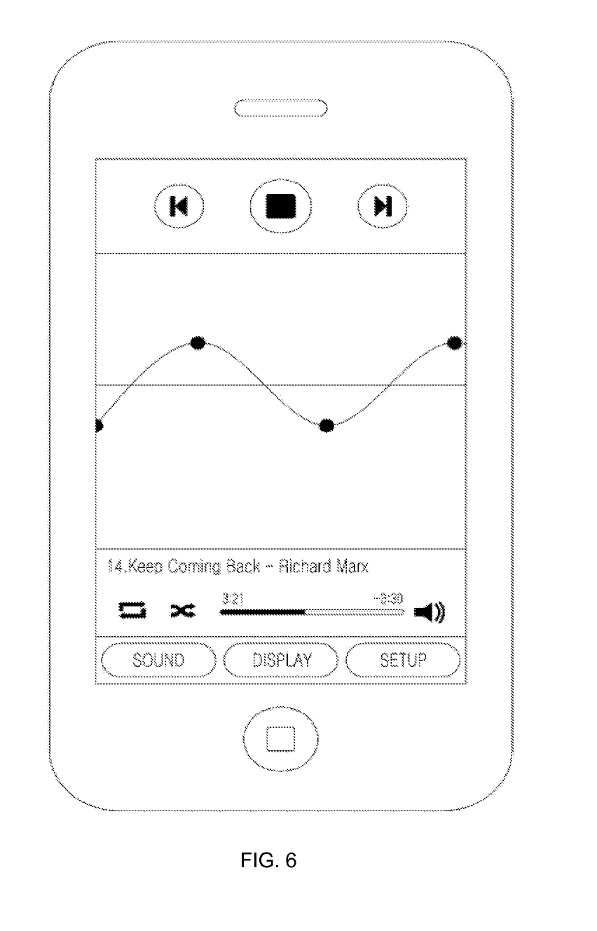

FIG. 6 is a view illustrating a smart device 200 in which sound data is outputted by a compensation signal in a method of providing a compensation service for the characteristics of a sound system 300 using the smart device 200 according to an embodiment of the present invention. As shown in FIG. 5, the service providing server 100 may receive information of the sound system 300 to retrieve the sound characteristics, and may transmit a compensation signal according to the sound characteristics, and thus the smart device 200 may compensate for an output parameter of the sound system 300 according to the compensation signal to output sound, and as shown in FIG. 6, may display the changed output parameter on the display unit of the smart device 200. According to embodiments, the output parameter that is compensated according to the compensation signal may also be variously displayed as images and animations as well as texts.

A method of providing a compensation service for the characteristics of a sound system using a smart device can perform equalizing in consideration of the output characteristics according to the sound systems, and is convenience for use because a user can be provided with a sound compensation service according to the sound characteristics of his/her sound system without directly finding the sound characteristics of his/her sound system, by allowing a service providing server to receiving information about the sound system from the smart device, retrieving the sound characteristics, and then transmitting a compensation signal according to the sound characteristics to the smart device.

The method of providing the compensation service for the characteristics of the sound system using the smart device can enable a change of a realistic tone and an expression about a space due to the reflection of the individual characteristics of the sound system even though the same artificial sound field is applied, by receiving sound setting information from the smart device and transmitting a compensation signal according to the sound characteristics and the sound setting information to the smart device while transmitting the compensation signal using the sound setting information in accordance with the taste of a user and reflecting the sound characteristics of the sound system.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing a compensation service for characteristics of a sound system using a smart device, the method comprising:
(0) storing, by a service providing server providing the sound compensation service, the characteristics according to the sound system in a database;
(1) receiving, by the service providing server, information of the sound system from the smart device;
(2) retrieving, by the service providing server, the inputted sound characteristics of the sound system; and
(3) transmitting, by the service providing server, a compensation signal according to the sound characteristics to the smart device,
wherein the smart device is installed with an application program for performing a compensation for the characteristics of the sound system, and the application program compensates for an output parameter of the sound system according to the compensation signal.

2. The method of claim 1, wherein the sound system comprises at least one of a speaker embedded in the smart device, an earphone, a headphone, and an external speaker.

3. The method of claim 1, wherein (1) the receiving of the information of the sound system comprises:
(1-1) transmitting a list of the sound systems to the smart device; and
(1-2) receiving at least one of the list from the smart device.

4. The method of claim 1, wherein in (1) the receiving of the information of the sound system, the information comprises manufacturer and product names.

5. The method of claim 1, further comprising receiving sound setting information from the smart device,
wherein (3) the transmitting of the compensation signal comprises transmitting a compensation signal according to the sound characteristics and the sound setting information.
